(19) United States
(12) Patent Application Publication
(10) Pub. No.: US 2025/0076496 A1
(43) Pub. Date: Mar. 6, 2025

(54) AUDIO-BASED DEVICE CONTEXT DETECTION

(71) Applicant: Intel Corporation, Santa Clara, CA (US)

(72) Inventors: Mariusz Pietrolaj, Gdansk (PL); Lukasz Kurylo, Gdansk (PL); Kuba Lopatka, Gdansk (PL); Marek Zabkiewicz, Gdynia (PL)

(73) Assignee: Intel Corporation, Santa Clara, CA (US)

(21) Appl. No.: 18/954,232

(22) Filed: Nov. 20, 2024

Related U.S. Application Data
(60) Provisional application No. 63/694,999, filed on Sep. 16, 2024.

(51) Int. Cl. G01S 15/04; G06F 1/3206

(52) U.S. Cl. CPC G01S 15/04; G06F 1/3206

(57) ABSTRACT

Systems and methods are provided for an acoustic-based determination that a device is inside a bag, enabling a device to react early to a potential hot bag scenario before the device begins to overheat. Acoustic cues associated with the device being put in a bag can be detected, and an ultrasonic echo can be analyzed to identify characteristics of reflections from a bag material. Ambient acoustics are used as a cue for hot bag detection, and acoustic analysis can be implemented in an audio digital signal processor, consuming a minimum amount of energy and allowing the acoustic-based device context detection method to function when the device is in standby, sleep, and/or hibernate mode. When the acoustic-based device context detection method determines that the device is inside a bag, the method prevents the device from entering a high power state, providing users with worry-free battery life.

### CROSS-REFERENCE TO RELATED APPLICATIONS

This application is related to and claims the benefit of priority under 35 U.S.C. § 119(e) to U.S. Provisional Application No. 63/694,999 titled “Audio-based Device Context Detection” filed on Sep. 16, 2024, which is hereby incorporated by reference in its entirety.

### TECHNICAL FIELD

This disclosure relates generally to device context detection, and in particular to an acoustic-based detector for identification of device environmental context.

### BACKGROUND

Mobile devices are often stored in environments that prevent device cooling, such as a closed bag, backpack, or pocket. This can lead to an issue often called the “hot bag” problem, which occurs when a device is placed in a bag but continues running. For example, a laptop may be placed in a bag while in sleep mode and may then unexpectedly wake up and continue running. This can cause the device to overheat and drain its battery, potentially damaging the device and the bag. In some examples, the culprit can be a background process (e.g., an operating system update) that starts running after the device is placed in the bag. While the device is in the bag, the device is not able to cool properly, thus using a lot more energy than required for the process and running down the battery. As a result, the user cannot use their device after it is taken out of the bag. The hot bag problem can be both inconvenient for the user as well as harmful to the device and the bag. Additionally, incidents of hot bag problems can be harmful to the device brand, as evidenced when selected brands and/or devices are banned from airplanes.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

Figures (FIGS. 1A and 1B illustrate examples of timelines showing a progression of battery drain in a device over time, in accordance with various embodiments.

FIG. 2 is a chart showing a sequence of states of an acoustic-based context detection system, in accordance with various embodiments.

FIG. 3 illustrates an example of acoustic cues associated with a bag event, in accordance with various embodiments.

FIGS. 4A-4B are block diagrams illustrating examples of an acoustic-based context detection system for determining a device environment, in accordance with various embodiments.

FIG. 5 is a block diagram illustrating an acoustic pipeline for ultrasound based environment classification, in accordance with various embodiments.

FIGS. 6A-6B show spectrograms illustrating a comparison of normalized impulse responses for various device states, in accordance with various embodiments.

FIG. 7 is a flowchart illustrating a method for acoustic-based context detection to determine whether a device is in a bag, in accordance with various embodiments.

FIG. 8 is a block diagram of an example deep learning system, in accordance with various embodiments.

FIG. 9 is a block diagram of an example computing device, in accordance with various embodiments.

### DESCRIPTION

### Overview

Systems and methods are provided for an acoustic-based determination that a device is inside an enclosure. For example, the acoustic-based context detection method can determine that a laptop is inside a backpack and prevent the laptop from performing optional processes while in the bag and overheating. The systems and methods for acoustic-based context detection include detecting the sound of the device being put in a bag, and confirming the device is in a bag by emitting an ultrasound signal (e.g., an ultrasound sequence or chirp), and analyzing an ultrasonic echo for characteristics of reflections from the bag material. In various implementations, acoustic processing can be performed in a digital signal processor (DSP) subsystem, allowing the acoustic-based device context detection method to function when the device is in standby, sleep, and/or hibernate mode. Thus, when the acoustic-based device context detection method determines that the device is inside a bag, the method prevents the device from entering a high power state.

While the hot bag problem has been a known issue for many years, traditional approaches are limited. For example, one approach to avoiding the hot bag problem is for the user to shut down the device instead of putting the device in sleep or hibernate mode. This relies on user knowledge of the problem and can limit resume-work features, since a user has to close and re-open all tabs, windows, and documents. Another approach is for the user to check that no background processes are running on the device while the laptop is switched to sleep or hibernate state. Unfortunately, most users lack technical skills required for such a check. Another check that can help prevent the hot bag problem is for the user to ensure that graphic related software is up to date. Although important, this approach does not resolve the issue, and covers just one of the factors that may impact the inability of the device to properly enter a sleep or hibernate state. One automated approach to preventing the hot bag problem is based on thermal sensors, which monitor the device and adjust the power profile when a high temperature scenario appears. While such an approach limits the risk of hardware damage and full battery drain, it does not enable early prevention before overheating and battery drain starts. In one example, a thermal-based approach includes intelligent power management features which adjust the device's power to avoid overheating or battery drain when a device is put in a bag. Factors that an intelligent power management system may consider include AC or battery modes, laptop lid state, laptop usage, equipment performance modes, and power and temperature of the device. However, traditional intelligent power management systems do not process the available signals in low power mode (e.g., standby, sleep, and/or hibernate modes), and instead process the available signals when the device is in a high power state. Thus, traditional power management systems do not prevent the device from entering a high power state.

According to various implementations, systems and methods are presented herein for acoustic-based context detection that enable a device to react early to a potential hot bag scenario before the device begins to overheat. The systems and methods can function in a low power state (e.g., standby mode, sleep mode, and/or hibernate mode) to prevent the device from entering a high power state. In particular, ambient acoustics are used as a cue for hot bag detection, and an acoustic analysis algorithm can be implemented in an audio DSP (digital signal processor), consuming a minimum amount of energy (e.g., less than 10 mW for audio processing). In some examples, implementation of the acoustic-based context detection systems and methods provided herein can provide users with worry-free battery life.

For purposes of explanation, specific numbers, materials, and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” or the phrase “A or B” means (A), (B), or (A and B). For the purposes of the present disclosure, the phrase “A, B, and/or C” or the phrase “A, B, or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or systems. Also, the term “or” refers to an inclusive “or” and not to an exclusive “or.”

The systems, methods, and devices of this disclosure each have several innovative aspects, no single one of which is solely responsible for all desirable attributes disclosed herein. Details of one or more implementations of the subject matter described in this specification are set forth in the description below and the accompanying drawings.

### Example Acoustic-Based Context Detection Systems and Methods

According to some embodiments, the acoustic-based context detection systems and methods leverage existing device hardware and software architecture to determine device environment and, in particular, to identify when the device is inside a bag or other enclosure. Device architecture includes a framework for running low power neural network algorithms. The neural network algorithms can include hardware acceleration. The acoustic-based context detection systems and methods can be integrated into mobile devices such as laptops.

FIG. 1A illustrates an example 100 of a timeline showing a progression of battery drain in a device over time. The device is used for work from 9 a.m. to 5 p.m. and is then placed in a bag. While the device is in the bag, a background process is executed, thereby draining the battery. In some examples, when a background process is executed while the device is in a bag, the device cannot ventilate and therefore cannot easily cool itself, thus using extra power to prevent overheating. As a result, the battery is drained while the device is in the bag, and the user cannot work on the device when it is reopened.

FIG. 1B illustrates an example 150 of a timeline showing a progression of battery drain over time in a device having an acoustic-context detection system as described herein, in accordance with various embodiments. Similar to the timeline shown in FIG. 1A, the device is used for work from 9 a.m. to 5 p.m. and is then placed in a bag. While the device is in the bag, the acoustic-context detection system prevents execution of a background process that could drain the battery. When the device lid is reopened at 10 p.m., the battery still has good charge and a background update can execute before (or while) the user begins working on the device. The user can be assured of continued battery life when re-opening the device in the evening, because the device is aware that it is placed in a bag and postpones the update.

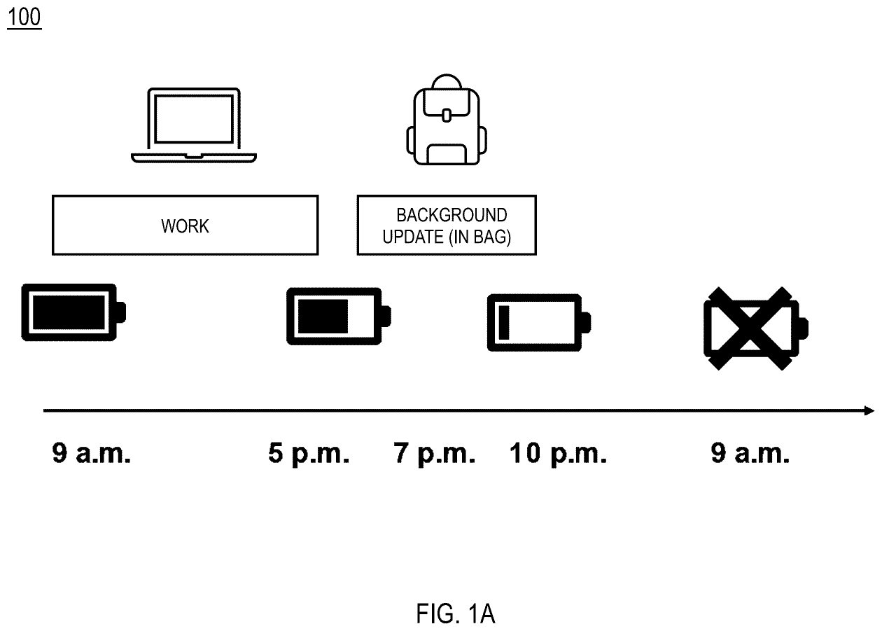

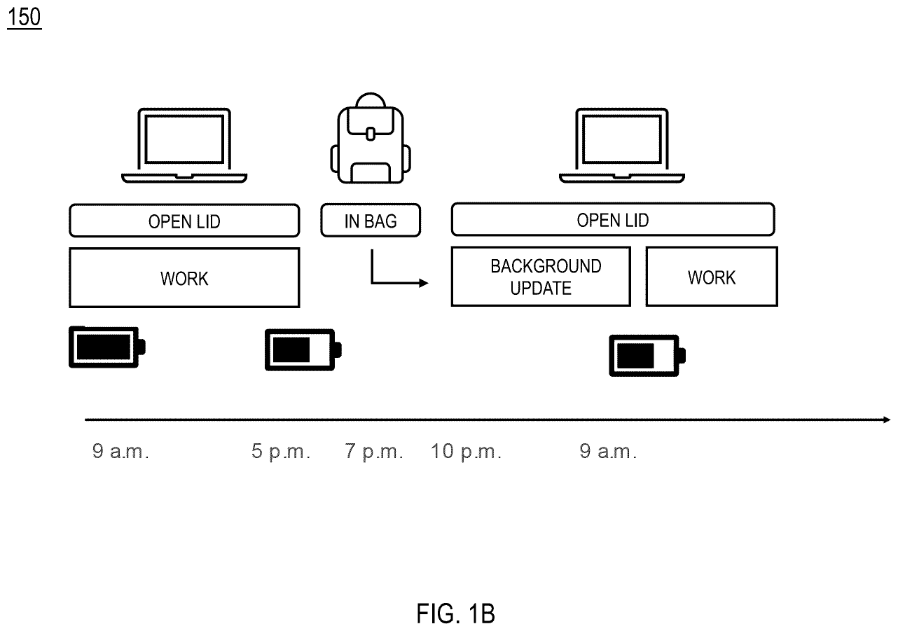

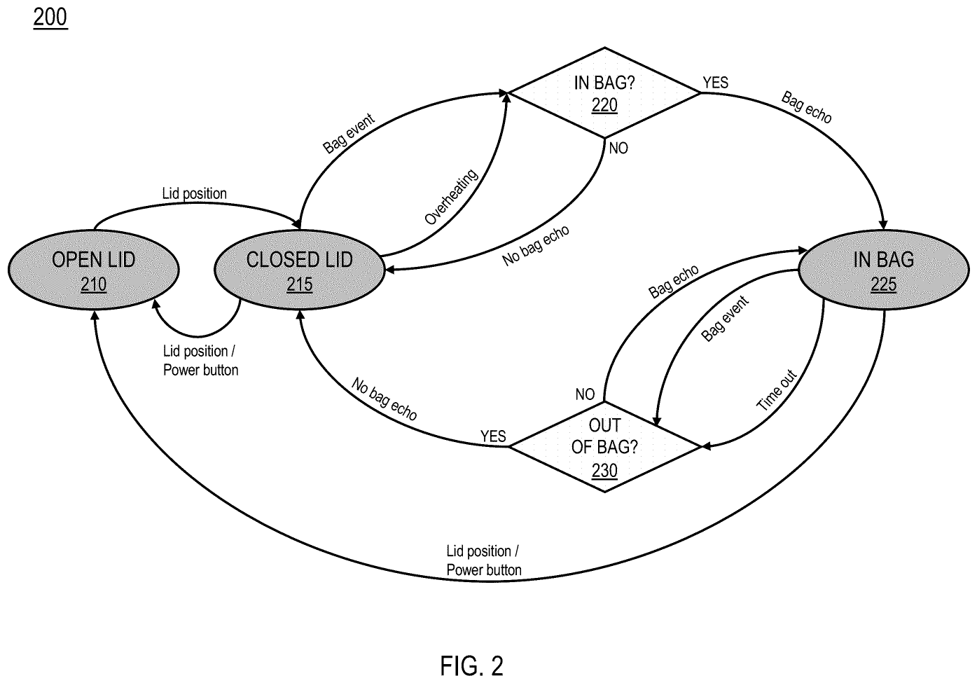

FIG. 2 is a chart 200 showing a sequence of states of an acoustic-based context detection system, in accordance with various embodiments. In some examples, the start state is the open lid state 210. Lid position sensors in the device can cause the state to transition to the closed lid state 215. From the closed lid state 215, the state can transition to an in-bag state 225 or back to the open lid state 210. In particular, from the closed lid state, the device can monitor for overheating and/or for a bag event. As used herein, the term “bag event” refers to the device being placed inside a bag or other enclosure. A bag event can be detected based on the sound of the device being put in a bag. Overheating can be detected by thermal sensors. If the device detects either a bag event or overheating, in order to determine whether the device has been moved to a bag or other enclosure, the device temporarily enters an “in-bag?” state 220 and the device performs a bag echo check. To perform a bag echo check, an ultrasound (ULS) signal is emitted from the device and the ultrasound echo is analyzed. The ultrasound signal can be, for example, a sequence, a pattern, a marker, an excitation, and/or a chirp. Ultrasonic reflections from a bag material are different from ultrasonic room echoes, which generally include reflections off hard surfaces in a room. Ultrasonic reflections from a within a bag are referred to as bag echoes herein. If no bag echo is detected at the “in-bag?” state 220, the device returns to the closed lid state 215. However, if a bag echo is detected at the “in-bag?” state 220, the device state changes to an in-bag state 225, in which the device is protected from overheating by preventing execution of CPU intensive applications in the background.

When the device is in the in-bag state 225, the device may remain in the in-bag state 225 until one of several events occurs. In one example, if the device lid position changes (e.g., a laptop lid is opened), the device will return to the open lid state 210. Similarly, if the device power button is activated, the device will return to the open lid state 210. In another example, if another bag event is detected, the device temporarily enters an “out of bag?” state 230 and the device performs another bag echo check to verify that the device is no longer inside a bag or other enclosure. Additionally, when in the in-bag state 225, the device can periodically time out of the in-bag state 225 and temporarily enter the “out of bag?” state 230. The time out period can be any selected length of time and, in some examples, the time out period prevents the device from locking in the in-bag state 225. In some examples, the time out period can be one minute, five minutes, ten minutes, twenty minutes, thirty minutes, or an hour. In some examples, the time out period can be adjustable. At the “out of bag?” state 230, the device performs a bag echo check. If a bag echo is detected at the “out of bag?” state 230, the device state returns to the in-bag state 225. If no bag echo is determined at the “out of bag?” state 230, the device returns to the closed lid state 215, in which the device operates as if the device is on a table or other surface with the lid closed (and not inside a bag).

At any time, the device lid may be opened. If the device lid position sensors indicate that the lid is open, the device state transitions back to the open lid state 210. Similarly, if the device power button is activated, the device state may transition back to the open lid state 210. In various implementations, audio framework infrastructure, audio framework neural networks, and/or audio framework neural network acceleration can be used as a foundation for the systems and methods described herein.

In various implementations, neural network models can be trained to focus on two aspects of hot bag scenarios. A first aspect is the detection of a bag event that would indicate a possible change of the acoustic environment of the device. The second aspect is the classification of the ultrasound response (e.g., an ultrasound echo after an ultrasound emission) to distinguish between “in the bag” and “outside the bag” acoustic environments. With respect to the first aspect, detection of a bag event, a bag event can be characterized by a high amplitude signal with rich low frequency content and possible clipping signal. The acoustics associated with a bag event can have an impulsive quality that is caused by the housing of the device rubbing against the bag walls. A bag event has a distinct acoustic cue, which enables robust detection of the bag event using acoustic event detection methods (e.g., neural network based acoustic event detection).

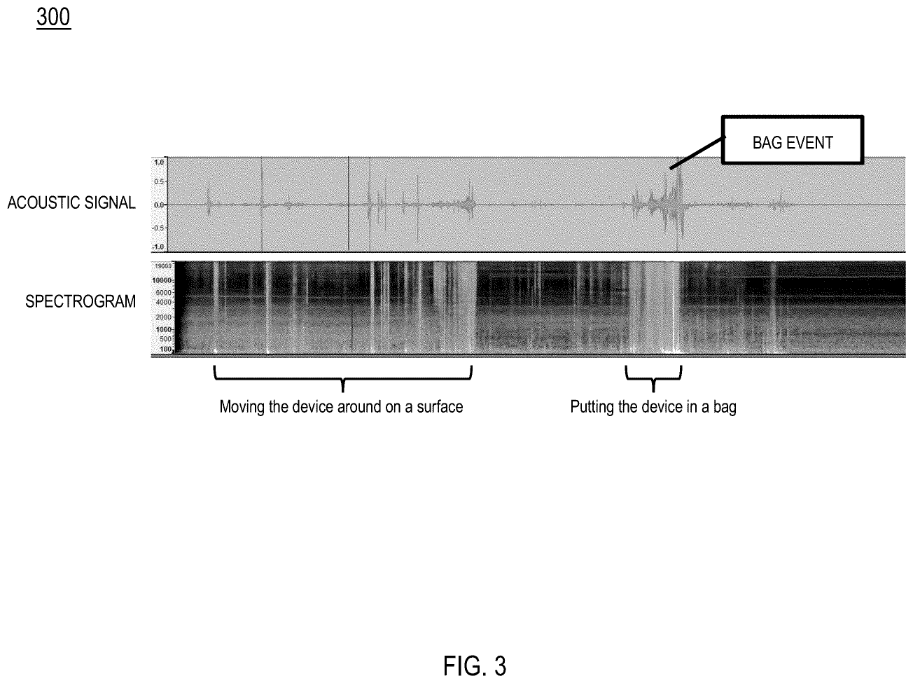

FIG. 3 illustrates an example 300 of the acoustic cues associated with a bag event, in accordance with various embodiments. In particular, the top graph in FIG. 3 shows the amplitude of the audio signal over time. The bottom graph in FIG. 3 is a spectrogram of the audio signal, showing the frequencies in the audio signal over time. As indicated in FIG. 3, the acoustics associated with a bag event (i.e., “putting the laptop in a bag”) are distinct from the acoustics associated with moving the device around on a surface such as a desk.

In various implementations, the acoustic cues associated with a bag event can be used separately as a standalone feature to identify a bag event. In some implementations, the acoustic cues associated with a bag event can be used in conjunction with other data to identify a bag event. In various examples, the acoustic-based context detection systems and methods for identifying a bag event are independent of the thermal state of the device, and thus a bag event and an in-bag device state can be detected before a device begins overheating.

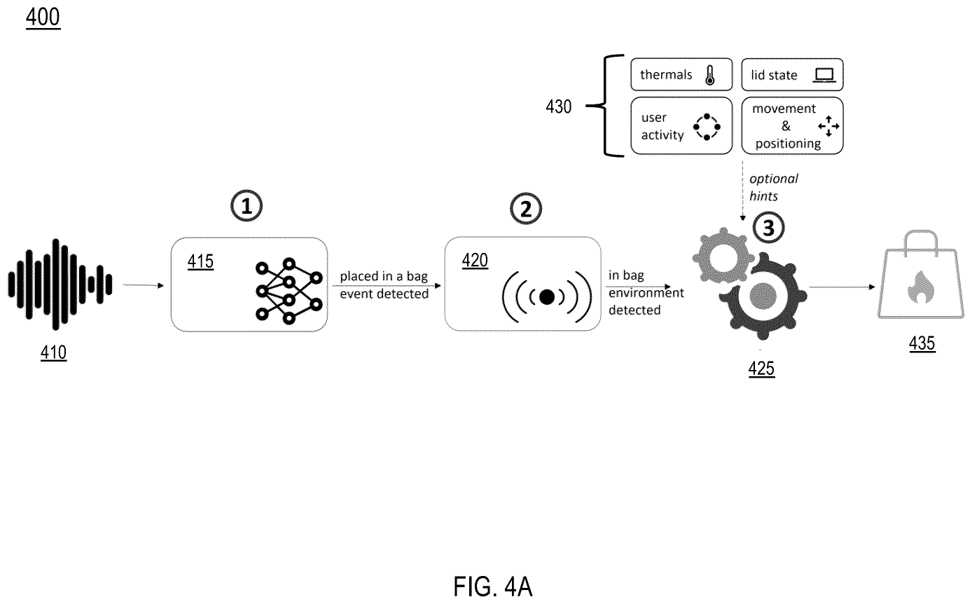

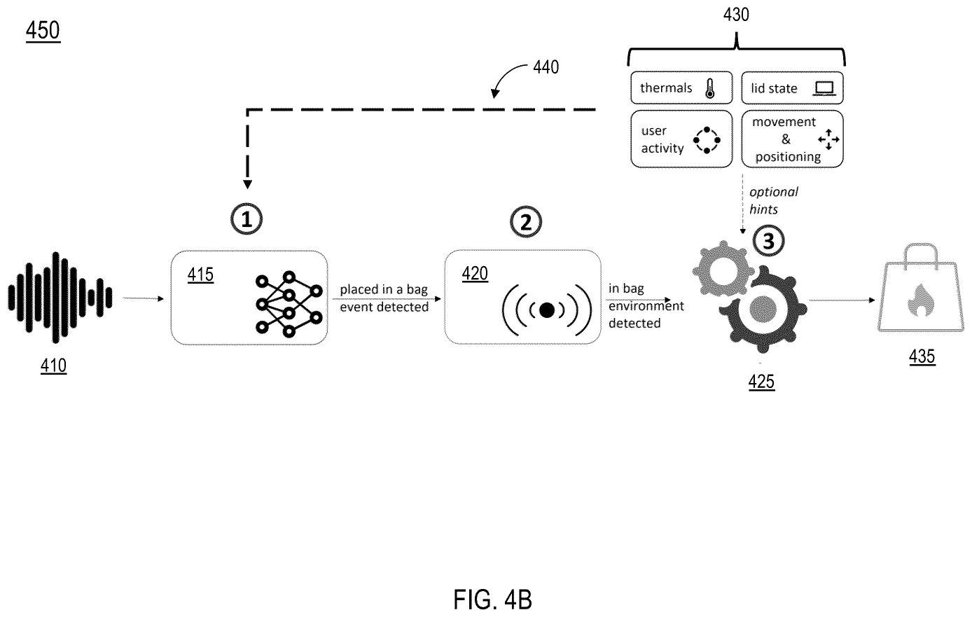

FIG. 4A is a block diagram illustrating an example of an acoustic-based context detection system 400 for determining a device environment, in accordance with various embodiments. The acoustic-based context detection system 400 receives audio input from the acoustic environment 410 around the device. In particular, microphones in the device receive audio input from the acoustic environment 410. The acoustic-based context detection system 400 includes an event detector 415 to analyze the acoustic environment 410 and detect acoustic cues indicating that the device was put into a bag. In some embodiments, the event detector 415 can be a low power neural network configured to analyze the audio input from the acoustic environment 410 and identify when the device is placed in a bag (i.e., identify a bag event).

The acoustic-based context detection system 400 also includes an ultrasound module 420 configured to confirm the in-bag state of the device following the detection of a bag event by the event detector. In particular, when the event detector 415 detects a bag event, the ultrasound module 420 generates an ultrasound chirp and analyzes the subsequent echo of the ultrasound chirp to determine whether the device in inside a bag or other enclosure. In particular, the echo from the ultrasound emission when the device is inside a bag is different and distinct from the echo from the ultrasound emission when the device is on an open surface and not inside an enclosure.

When the ultrasound module 420 determines that the device is in a bag, the in-bag determination is received at a decision module 425 for a final in-bag detection decision. In some examples, the decision module 425 receives additional data regarding potential in-bag factors 430, such as thermal data, user activity data, lid state data, and device movement and positioning data. Any of these factors can be considered by the decision module 425 in determining whether the device is in a bag or other enclosure. For example, if the device lid is open, the decision module 425 can determine that the device is not in an enclosure. Similarly, if there is user activity on the device, the decision module 425 can determine that the device is not in an enclosure. As shown in FIG. 4A, the additional factors 430 are considered when the ultrasound module 420 makes the in-bag detection determination.

In various examples, the acoustic-based context detection system 400 is gated by a low power acoustic event detector, and thus consumes minimal power. In some examples, the acoustic-based context detection system 400 uses less than about 18 mW of power, and thus can run while a device is in a low power state such as a sleep mode and/or a hibernate mode.

FIG. 4B is a block diagram illustrating an example of an acoustic-based context detection system 450 for determining a device environment, in accordance with various embodiments. While the acoustic-based context detection system 450 is similar to the acoustic-based context detection system 400, in the acoustic-based context detection system 450, the additional factors 430 are considered before the event detector 415 analyzes the acoustic environment 410 and detects acoustic cues indicating that the device was put into a bag. In some examples, the additional factors 430 can be used to trigger event detection by the event detector 415. Similarly, in some examples, the additional factors 430 can prevent the event detector 415 from analyzing the acoustic environment 410 to detect a bag event. For example, if it is determined that the device lid is open, it is also determined that the device is not in a bag or other enclosure, and the event detector 415 does not proceed to analyze the acoustic cues and look for a bag event. Similarly, if it is determined that there is user activity on the device (e.g., a user typing on the keyboard or using the mouse), it is also determined that the device is not in a bag or other enclosure, and the event detector 415 does not proceed to analyze the acoustic cues and look for a bag event. Thus, in some examples, the acoustic-based context detection system 450 allows for the in-bag detection systems and methods to occur in a staged manner, and thereby limits the power usage of the system 450. A low power neural network system can allow for early bag-related activity detection and also gates the flow of the further stages of the system. In some examples, the systems and methods presented herein avoid generation of unnecessary ultrasound signals and/or execution of a final decision algorithm.

When the additional factors 430 indicate the possibility of a bag event, the acoustic-based context detection system 450 event detector 415 can analyze the acoustic environment 410 and detect acoustic cues indicating that the device was put into a bag. Additionally, the acoustic-based context detection system 450 includes an ultrasound module 420 configured to confirm the in-bag state of the device following the detection of a bag event by the event detector.

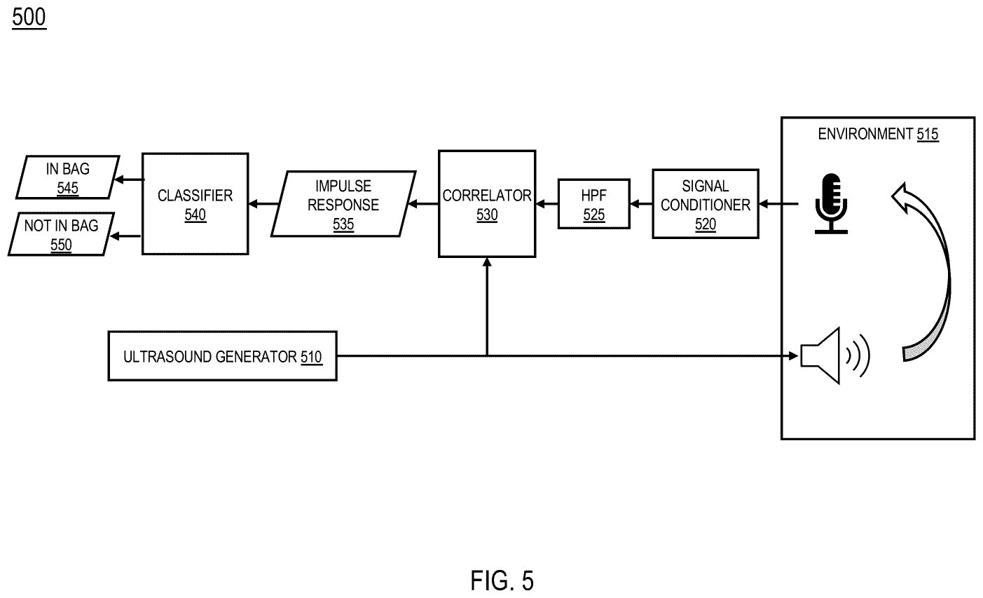

FIG. 5 is a block diagram illustrating an audio pipeline 500 for ultrasound based environment classification, in accordance with various embodiments. In some examples, the block diagram of FIG. 5 illustrates the ultrasound module 420 of FIGS. 4A and 4B. The pipeline 500 includes an ultrasound generator 510, which can be an ultrasound sequence generator. The ultrasound generator 510 can emit an ultrasound chirp, another ultrasound sequence, and/or multiple bands of ultrasound frequencies. The ultrasound emission is transmitted from a device speaker to the environment 515, and reflections and/or echoes of the ultrasound emission are received at a device microphone. The received ultrasound echoes are processed at a signal conditioning module 520 and filtered at the high pass filter 525. A correlator 530 compares the emitted ultrasound with the filtered received ultrasound echo and outputs an Estimated Impulse Response 535. In various examples, the Estimated Impulse Response allows for analysis of energy levels of early reflections versus late reflections resulting from the environment in which the device and its speakers and microphones are placed. When the device is enclosed in a container such as bag or backpack, the surrounding surfaces are very close to the device, resulting in early reflections of ultrasound signals. Additionally, enclosing the device in a backpack or bag attenuates reflection from external surfaces from the outside of the backpack or bag. When the device is out on a surface and not enclosed in a container, the surrounding surfaces are relatively far from the device, resulting in late reflections of ultrasound signals. An environment classifier 540 can distinguish between early reflections and late reflections and determine whether the device is in an in-bag state 545 or in an out of bag state 550.

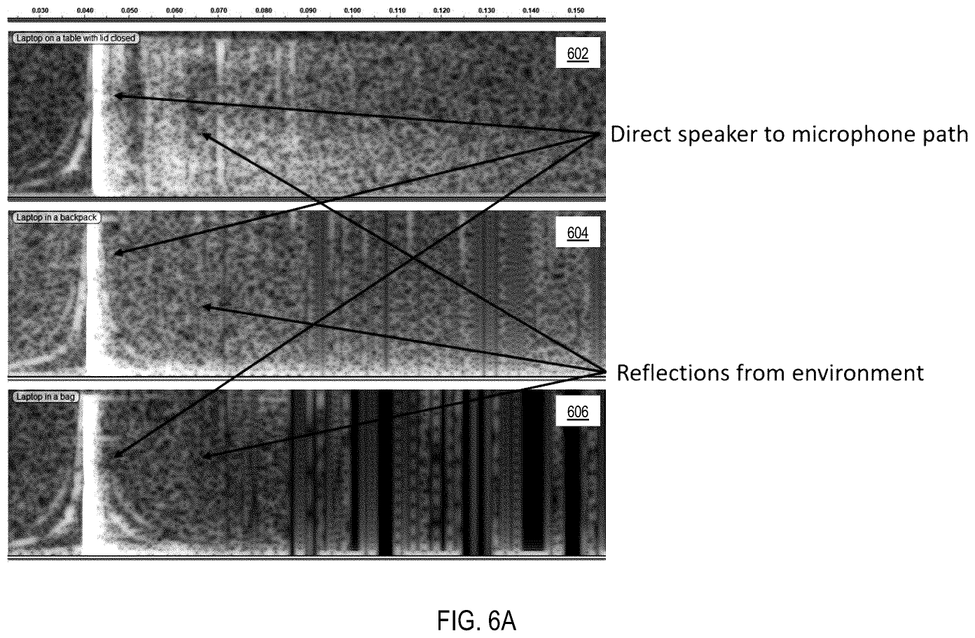

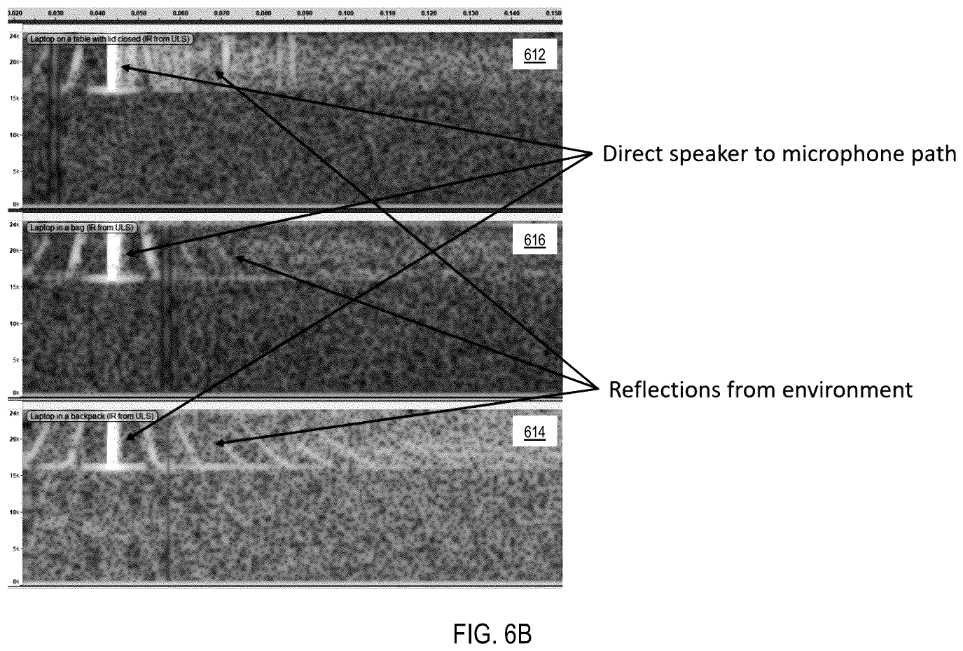

FIG. 6A shows spectrograms illustrating a comparison of normalized impulse responses for a laptop on a table with a closed lid (602), and a laptop in an enclosed environment, such as a backpack (604) or in a bag (606). Impulse Responses when the device is placed in a backpack or a bag have visibly less energy following the initial direct path component indicating the direct speaker to microphone path. In particular, the reflections from the environment have less energy in the scenarios in which the device is in a backpack (604) or in a bag (606) as compared to the reflections from the environment when the device is on a table (602). This difference can be used as a base for a classifier to provide information about a detected environment type.

FIG. 6B shows spectrograms illustrating a comparison of normalized ultrasound impulse responses for a laptop on a table with a closed lid (602), and a laptop in an enclosed environment, such as a backpack (604) or a bag (606). In particular, the impulse responses shown in FIG. 6B are impulse responses from ultrasound signal emissions. As shown in FIG. 6B, the difference in energy level for ultrasound signal reflections from the environment is similar to that shown in FIG. 6A. In particular, the ultrasound signal reflections from the environment have less energy in the scenarios in which the device is in a backpack (604) or in a bag (606) as compared to the reflections from the environment when the device is on a table (602). In some examples, visible correlation aliasing can be controlled with the selection of the transmitted ultrasound sequence.

### Example Acoustic-Based Context Detection Method

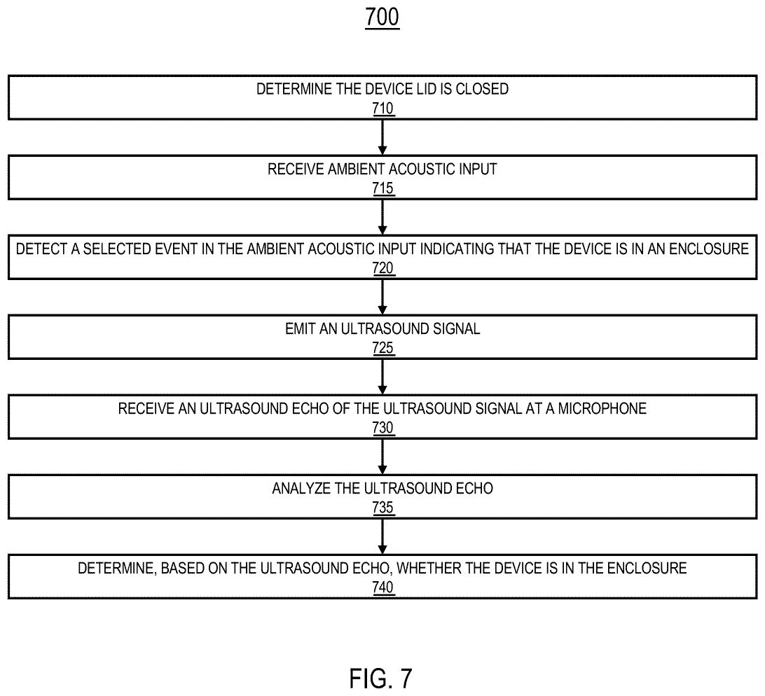

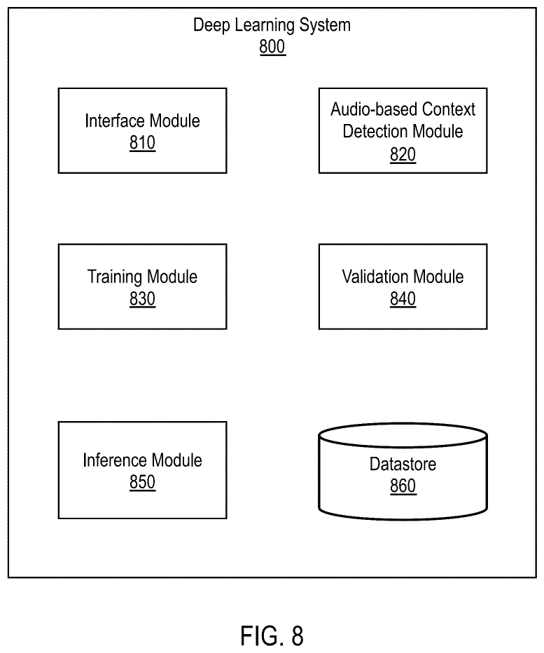

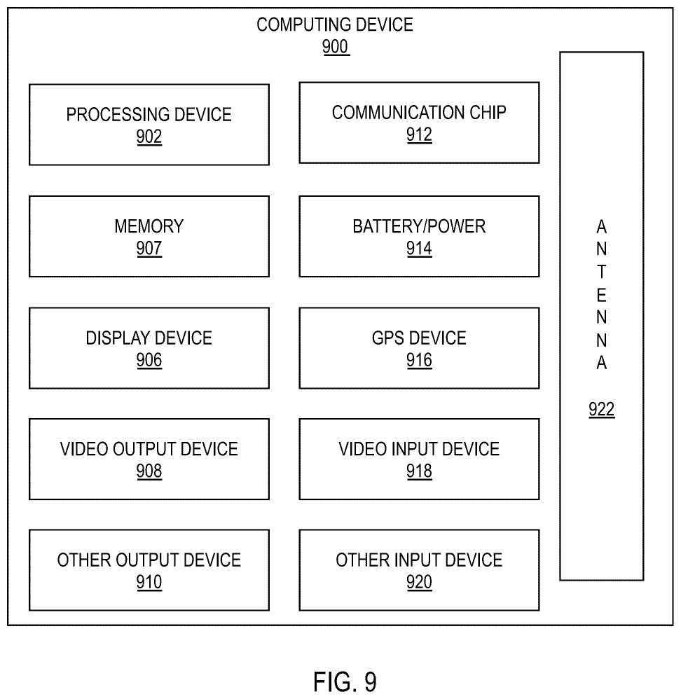

FIG. 7 is a flowchart illustrating a method 700 for acoustic-based context detection to determine whether a device is in a bag, in accordance with various embodiments. The method 700 may be performed by the deep learning system 800 in FIG. 8 and the method 700 may be performed by the computing device 900 in FIG. 9. Although the method 700 is described with reference to the flowchart illustrated in FIG. 7, many other methods for acoustic-based context detection may alternatively be used. For example, the order of execution of the steps in FIG. 7 may be changed. As another example, some of the steps may be changed, eliminated, or combined.

At step 710, it is determined whether the device lid is closed or open. In particular, if a device lid is open, the method 700 ends until the device lid is closed. A bag event is not detected unless the device lid is closed, since the device is generally not placed in an enclosure such as a bag or backpack unless the lid is closed.

At step 715, ambient audio input is received. In particular, the ambient audio input can include the acoustics of the environment surrounding the device. The ambient audio input is received at one or more device microphones. The ambient audio input can be analyzed by an event detector, such as the event detector 415 described with respect to FIGS. 4A and 4B. The event detector analyzes the ambient audio input for a bag event. At step 720, a selected event is detected in the ambient audio input, where the selected event indicates that the device has been placed in an enclosure. In some examples, an acoustic pattern can be identified in the ambient audio input, where the acoustic pattern indicates a bag event.

At step 725, an ultrasound signal is emitted from the device. In particular, after a bag event is detected, an ultrasound signal is emitted to confirm that the bag event detection was accurate and that the device has been placed in a bag. The device can generate the ultrasound signal and emit the ultrasound signal from device speakers. The ultrasound signal can include multiple ultrasound frequencies. In some examples, the ultrasound signal is an ultrasound chirp.

At step 730, an echo from the ultrasound signal emission is received at one or more device microphones. In particular, the device microphone receives the ultrasound signal directly from the speakers, and subsequent to the direct speaker-to-microphone signal, the device microphone receives an ultrasound echo, which is the ultrasound signal as reflected off a surface. When the device is in a bag, the ultrasound echo will arrive after a short time period since the bag surfaces are close to the device, and when the device is on a table or other surface, the ultrasound echo will arrive after a longer time period. Additionally, the ultrasound echo may be a weaker signal when reflected off an absorbent surface such as a bag material.

At step 735, the ultrasound echo received by the one or more device microphones is analyzed. In some examples, the ultrasound echo is analyzed at an audio framework. In some examples, the ultrasound echo is analyzed by a deep learning system such as a neural network. The acoustics of the ultrasound echo can be used to identify whether the device is inside an enclosure such as a backpack or other bag, and whether the device is on a table and not enclosed.

At step 740, it is determined, based on the ultrasound echo, whether the device is in an enclosure such as a backpack or other bag. In some examples, an audio framework and/or a neural network determine whether the device is in an enclosure. When it is determined that the device is in an enclosure, the device can enter an in-bag state as described above, in which the device remains in a low power mode and does not begin any updates or other operations that consume more than minimal battery power. When it is determined that the device is not in an enclosure, the device can return to (or remain in) an awake mode and/or a mode in which updates and other operations can proceed. In general, when the device is in an enclosure, it can be difficult to cool the device when it begins to heat up, and therefore updates and other operations can consume more power than the same operations consume when the device is on a surface such as a table or desk.

### Example Deep Learning System

FIG. 8 is a block diagram of an example deep learning system 800, in accordance with various embodiments. The deep learning system 800 trains deep neural networks (DNNs) for various tasks, including acoustic-based context detection. The deep learning system 800 includes an interface module 810, an acoustic-based context detection module 820, a training module 830, a validation module 840, an inference module 850, and a datastore 860. In other embodiments, alternative configurations, different or additional components may be included in the deep learning system 800. Further, functionality attributed to a component of the deep learning system 800 may be accomplished by a different component included in the deep learning system 800 or a different system. The deep learning system 800 or a component of the deep learning system 800 (e.g., the training module 830 or inference module 850) may include the computing device 900 in FIG. 9.

The interface module 810 facilitates communications of the deep learning system 800 with other systems. As an example, the interface module 810 supports the deep learning system 800 to distribute trained DNNs to other systems, e.g., computing devices configured to apply DNNs to perform tasks. As another example, the interface module 810 establishes communications between the deep learning system 800 with an external database to receive data that can be used to train DNNs or input into DNNs to perform tasks. In some embodiments, data received by the interface module 810 may have a data structure, such as a matrix. In some embodiments, data received by the interface module 810 may be audio, such as an audio stream.

The acoustic-based context detection module 820 processes the input audio to identify signals in the input data. In general, the acoustic-based context detection module 820 reviews the input data and determines whether the acoustic cues indicate that the device has been placed in a bag or enclosure. During training, the acoustic-based context detection module 820 is fed large amounts of preprocessed data, including, for example, audio data, and the acoustic-based context detection module 820 learns to identify a bag event.

The training module 830 trains DNNs by using training datasets. In some embodiments, a training dataset for training a DNN may include audio streams. In some examples, the training module 830 trains the acoustic-based context detection module 820. The training module 830 may receive real-world audio data including bag events for processing with the acoustic-based context detection module 820 as described herein.

In some embodiments, a part of the training dataset may be used to initially train the acoustic-based context detection module 820, and the rest of the training dataset may be held back as a validation subset used by the validation module 840 to validate performance of a trained acoustic-based context detection module 820. The portion of the training dataset not including the tuning subset and the validation subset may be used to train the acoustic-based context detection module 820.

The training module 830 also determines hyperparameters for training the acoustic-based context detection module. Hyperparameters are variables specifying the acoustic-based context detection module training process. Hyperparameters are different from parameters inside the acoustic-based context detection module (e.g., weights of filters). In some embodiments, hyperparameters include variables determining the architecture of the acoustic-based context detection module, such as number of hidden layers, etc. Hyperparameters also include variables which determine how the acoustic-based context detection module is trained, such as batch size, number of epochs, etc. A batch size defines the number of training samples to work through before updating the parameters of the acoustic-based context detection module. The batch size is the same as or smaller than the number of samples in the training dataset. The training dataset can be divided into one or more batches. The number of epochs defines how many times the entire training dataset is passed through the entire network. The number of epochs defines the number of times that the deep learning algorithm works through the entire training dataset. One epoch means that each training sample in the training dataset has had an opportunity to update the parameters inside the acoustic-based context detection module. An epoch may include one or more batches. The number of epochs may be 1, 10, 50, 100, or even larger.

The training module 830 defines the architecture of the acoustic-based context detection module, e.g., based on some of the hyperparameters. The architecture of the acoustic-based context detection module includes an input layer, an output layer, and a plurality of hidden layers. The input layer of an acoustic-based context detection module may include tensors (e.g., a multidimensional array) specifying attributes of the input, such as weights and biases, attention scores, and/or activations. The output layer includes labels of objects in the input layer. The hidden layers are layers between the input layer and output layer. In various examples, the acoustic-based context detection module can be a transformer model, a recurrent neural network (RNN), and/or a deep neural network (DNN). When the acoustic-based context detection module includes a convolutional neural network (CNN), the hidden layers may include one or more convolutional layers and one or more other types of layers, such as pooling layers, fully connected layers, normalization layers, softmax or logistic layers, and so on. The convolutional layers of the DNN abstract the input to a feature map that is represented by a tensor specifying the features. A pooling layer is used to reduce the spatial volume of input after convolution. It is used between two convolution layers. A fully connected layer involves weights, biases, and neurons. It connects neurons in one layer to neurons in another layer. It is used to classify input between different categories by training.

In the process of defining the architecture of the DNN, the training module 830 also adds an activation function to a hidden layer or the output layer. An activation function of a layer transforms the weighted sum of the input of the layer to an output of the layer. The activation function may be, for example, a rectified linear unit activation function, a tangent activation function, or other types of activation functions.

After the training module 830 defines the architecture of the acoustic-based context detection module 820, the training module 830 inputs a training dataset into the acoustic-based context detection module 820. The training dataset includes a plurality of training samples. An example of a training dataset includes a series of audio tokens of an audio stream.

The training module 830 may train the acoustic-based context detection module for a predetermined number of epochs. The number of epochs is a hyperparameter that defines the number of times that the deep learning algorithm will work through the entire training dataset. One epoch means that each sample in the training dataset has had an opportunity to update internal parameters of the DNN. After the training module 830 finishes the predetermined number of epochs, the training module 830 may stop updating the parameters in the DNN. The DNN having the updated parameters is referred to as a trained DNN.

The validation module 840 verifies accuracy of trained DNNs. In some embodiments, the validation module 840 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validation module 840 may determine an accuracy score measuring the precision, recall, or a combination of precision and recall of the acoustic-based context detection module. The validation module 840 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The validation module 840 may compare the accuracy score with a threshold score. In an example where the validation module 840 determines that the accuracy score of the augmented model is lower than the threshold score, the validation module 840 instructs the training module 830 to re-train the acoustic-based context detection module. In one embodiment, the training module 830 may iteratively re-train the acoustic-based context detection module until the occurrence of a stopping condition, such as the accuracy measurement indication that the acoustic-based context detection module may be sufficiently accurate, or a number of training rounds having taken place.

The inference module 850 applies the trained or validated acoustic-based context detection module to perform tasks. The inference module 850 may run inference processes of a trained or validated acoustic-based context detection module. In some examples, inference makes use of the forward pass to produce model-generated output for unlabeled real-world data. For instance, the inference module 850 may input real-world data into the acoustic-based context detection module and receive an output of the acoustic-based context detection module. The output of the acoustic-based context detection module may provide a solution to the task for which the acoustic-based context detection module is trained for.

The inference module 850 may aggregate the outputs of the acoustic-based context detection module to generate a final result of the inference process. In some embodiments, the inference module 850 may distribute the acoustic-based context detection module to other systems, e.g., computing devices in communication with the deep learning system 800, for the other systems to apply the acoustic-based context detection module to perform the tasks. The distribution of the acoustic-based context detection module may be done through the interface module 810. In some embodiments, the deep learning system 800 may be implemented in a server, such as a cloud server, an edge service, and so on. The computing devices may be connected to the deep learning system 800 through a network. Examples of the computing devices include edge devices.

The datastore 860 stores data received, generated, used, or otherwise associated with the deep learning system 800. For example, the datastore 860 stores video processed by the acoustic-based context detection module 820 or used by the training module 830, validation module 840, and the inference module 850. The datastore 860 may also store other data generated by the training module 830 and validation module 840, such as the hyperparameters for training acoustic-based context detection modules, internal parameters of trained acoustic-based context detection modules (e.g., values of tunable parameters of activation functions, such as Fractional Adaptive Linear Units (FALUs)), etc. In the embodiment of FIG. 8, the datastore 860 is a component of the deep learning system 800. In other embodiments, the datastore 860 may be external to the deep learning system 800 and communicate with the deep learning system 800 through a network.

### Example Computing Device

FIG. 9 is a block diagram of an example computing device 900, in accordance with various embodiments. In some embodiments, the computing device 900 may be used for at least part of the systems in FIGS. 1-8. A number of components are illustrated in FIG. 9 as included in the computing device 900, but any one or more of these components may be omitted or duplicated, as suitable for the application. In some embodiments, some or all of the components included in the computing device 900 may be attached to one or more motherboards. In some embodiments, some or all of these components are fabricated onto a single system on a chip (SoC) die. Additionally, in various embodiments, the computing device 900 may not include one or more of the components illustrated in FIG. 9, but the computing device 900 may include interface circuitry for coupling to the one or more components. For example, the computing device 900 may not include a display device 906, but may include display device interface circuitry (e.g., a connector and driver circuitry) to which a display device 906 may be coupled. In another set of examples, the computing device 900 may not include a video input device 918 or a video output device 908, but may include video input or output device interface circuitry (e.g., connectors and supporting circuitry) to which a video input device 918 or video output device 908 may be coupled.

The computing device 900 may include a processing device 902 (e.g., one or more processing devices). The processing device 902 processes electronic data from registers and/or memory to transform that electronic data into other electronic data that may be stored in registers and/or memory. The computing device 900 may include a memory 904, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 904 may include memory that shares a die with the processing device 902. In some embodiments, the memory 904 includes one or more non-transitory computer-readable media storing instructions executable for occupancy mapping or collision detection, e.g., the method described above in conjunction with FIGS. 4A-4B or some operations performed by the DNN system 800 in FIG. 8. The instructions stored in the one or more non-transitory computer-readable media may be executed by the processing device 902.

In some embodiments, the computing device 900 may include a communication chip 912 (e.g., one or more communication chips). For example, the communication chip 912 may be configured for managing wireless communications for the transfer of data to and from the computing device 900. The term “wireless” and its derivatives may be used to describe circuits, devices, systems, methods, techniques, communications channels, etc., that may communicate data using modulated electromagnetic radiation through a nonsolid medium. The term does not imply that the associated devices do not contain any wires, although in some embodiments they might not.

The communication chip 912 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 912 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 512 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 512 may operate in accordance with code-division multiple access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 512 may operate in accordance with other wireless protocols in other embodiments. The computing device 900 may include an antenna 922 to facilitate wireless communications and/or to receive other wireless communications (such as AM or FM radio transmissions).

In some embodiments, the communication chip 912 may manage wired communications, such as electrical, optical, or any other suitable communication protocols (e.g., the Ethernet). As noted above, the communication chip 912 may include multiple communication chips. For instance, a first communication chip 912 may be dedicated to shorter-range wireless communications such as Wi-Fi or Bluetooth, and a second communication chip 912 may be dedicated to longer-range wireless communications such as global positioning system (GPS), EDGE, GPRS, CDMA, WiMAX, LTE, EV-DO, or others. In some embodiments, a first communication chip 912 may be dedicated to wireless communications, and a second communication chip 912 may be dedicated to wired communications.

The computing device 900 may include battery/power circuitry 914. The battery/power circuitry 914 may include one or more energy storage devices (e.g., batteries or capacitors) and/or circuitry for coupling components of the computing device 900 to an energy source separate from the computing device 900 (e.g., AC line power).

The computing device 900 may include a display device 906 (or corresponding interface circuitry, as discussed above). The display device 906 may include any visual indicators, such as a heads-up display, a computer monitor, a projector, a touchscreen display, a liquid crystal display (LCD), a light-emitting diode display, or a flat panel display, for example.

The computing device 900 may include a video output device 908 (or corresponding interface circuitry, as discussed above). The video output device 908 may include any device that generates an audible indicator, such as speakers, headsets, or earbuds, for example.

The computing device 900 may include a video input device 918 (or corresponding interface circuitry, as discussed above). The video input device 918 may include any device that generates a signal representative of a sound, such as microphones, microphone arrays, or digital instruments (e.g., instruments having a musical instrument digital interface (MIDI) output).

The computing device 900 may include a GPS device 916 (or corresponding interface circuitry, as discussed above). The GPS device 916 may be in communication with a satellite-based system and may receive a location of the computing device 900, as known in the art.

The computing device 900 may include another output device 910 (or corresponding interface circuitry, as discussed above). Examples of the other output device 910 may include a video codec, a video codec, a printer, a wired or wireless transmitter for providing information to other devices, or an additional storage device.

The computing device 900 may include another input device 920 (or corresponding interface circuitry, as discussed above). Examples of the other input device 920 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 900 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 900 may be any other electronic device that processes data.

### Select Examples

Example 1 provides a method for context detection for a device, including receiving an ambient audio input; detecting a selected event in the ambient audio input, where the selected event indicates the device is in an enclosure; generating an ultrasound signal; analyzing an ultrasound echo of the ultrasound signal; and determining, based on the ultrasound echo, that the device is in the enclosure.

Example 2 provides the method of example 1, further including limiting the device to a lower power state while the device is in the enclosure.

Example 3 provides the method of example 1, further including determining a device lid state indicating a device lid is closed.

Example 4 provides the method of example 1, where analyzing the ultrasound echo includes inputting the ultrasound echo to a neural network, and determining that the device is in the enclosure includes determining by the neural network that the device is in the enclosure.

Example 5 provides the method of example 1, where analyzing the ultrasound echo includes comparing, at a correlator, the ultrasound echo to the ultrasound signal and identifying early reflections.

Example 6 provides the method of example 1, further including preventing the device from entering a high power state.

Example 7 provides the method of example 1, where the selected event is a first selected event, and further including detecting a second selected event in the ambient audio input, where the second selected event indicates the device is out of the enclosure.

Example 8 provides one or more non-transitory computer-readable media storing instructions executable to perform operations, the operations including receiving an ambient audio input; detecting a selected event in the ambient audio input, where the selected event indicates the device is in an enclosure; generating an ultrasound signal; analyzing an ultrasound echo of the ultrasound signal; and determining, based on the ultrasound echo, that the device is in the enclosure.

Example 9 provides the one or more non-transitory computer-readable media of example 8, the operations further including limiting the device to a lower power state while the device is in the enclosure.

Example 10 provides the one or more non-transitory computer-readable media of example 8, the operations further including determining a device lid state indicating a device lid is closed.

Example 11 provides the one or more non-transitory computer-readable media of example 8, where analyzing the ultrasound echo includes inputting the ultrasound echo to a neural network, and where determining that the device is in the enclosure includes determining by the neural network that the device is in the enclosure.

Example 12 provides the one or more non-transitory computer-readable media of example 8, where analyzing the ultrasound echo includes comparing, at a correlator, the ultrasound echo to the ultrasound signal and identifying early reflections.

Example 13 provides the one or more non-transitory computer-readable media of example 8, the operations further including preventing the device from entering a high power state.

Example 14 provides the one or more non-transitory computer-readable media of example 8, where the selected event is a first selected event, and further including detecting a second selected event in the ambient audio input, where the second selected event indicates the device is out of the enclosure.

Example 15 provides an apparatus, including a computer processor for executing computer program instructions; and a non-transitory computer-readable memory storing computer program instructions executable by the computer processor to perform operations including receiving an ambient audio input; detecting a selected event in the ambient audio input, where the selected event indicates the device is in an enclosure; generating an ultrasound signal; analyzing an ultrasound echo of the ultrasound signal; and determining, based on the ultrasound echo, that the device is in the enclosure.

Example 16 provides the apparatus of example 15, the operations further including limiting the device to a lower power state while the device is in the enclosure.

Example 17 provides the apparatus of example 15, the operations further including determining a device lid state indicating a device lid is closed.

Example 18 provides the apparatus of example 15, where analyzing the ultrasound echo includes inputting the ultrasound echo to a neural network, and where determining that the device is in the enclosure includes determining by the neural network that the device is in the enclosure.

Example 19 provides the apparatus of example 15, where analyzing the ultrasound echo includes comparing, at a correlator, the ultrasound echo to the ultrasound signal and identifying early reflections.

Example 20 provides the apparatus of example 15, the operations further including preventing the device from entering a high power state.

Example 21 provides the method of example 1, where analyzing the ultrasound echo includes comparing the ultrasound echo to the ultrasound signal and identifying echoes characteristic of bag material.

Example 22 provides a system for acoustic-based context detection for a device, comprising a microphone for receiving an ambient acoustic input; an event detector for detecting a selected event in the ambient acoustic input, wherein the selected event indicates the device is in an enclosure; a speaker for emitting an ultrasound signal; a correlator for analyzing an ultrasound echo of the ultrasound signal; and a decision module for determining, based on the ultrasound echo, that the device is in the enclosure.

Example 23 provides the method of claim 1, further comprising receiving a lid state, wherein the lid state indicates a device lid is closed.

Example 24 provides the method of claim 1, further comprising receiving device thermal data, wherein the thermal data indicates a device temperature is increasing.

Example 25 provides the method of claim 1, further comprising receiving device movement data, wherein the device movement data indicates the device is being moved.

Example 26 provides the one or more non-transitory computer-readable media of example 8, further comprising receiving a lid state, wherein the lid state indicates a device lid is closed.

Example 27 provides the one or more non-transitory computer-readable media of example 8, further comprising receiving device thermal data, wherein the thermal data indicates a device temperature is increasing.

Example 28 provides the one or more non-transitory computer-readable media of example 8, further comprising receiving a lid state, wherein the lid state indicates a device lid is closed.

Example 29 provides the apparatus of example 15, the operations further including receiving a lid state, wherein the lid state indicates a device lid is closed.

Example 30 provides the apparatus of example 15, the operations further including receiving device thermal data, wherein the thermal data indicates a device temperature is increasing.

Example 31 provides the apparatus of example 15, the operations further including receiving a lid state, wherein the lid state indicates a device lid is closed.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A method for context detection for a device, comprising:
receiving an ambient acoustic input;
detecting a selected event in the ambient acoustic input, wherein the selected event indicates the device is in an enclosure;
generating an ultrasound signal;
analyzing an ultrasound echo of the ultrasound signal; and
determining, based on the ultrasound echo, that the device is in the enclosure.

2. The method of claim 1, further comprising limiting the device to a low power state while the device is in the enclosure.

3. The method of claim 1, further comprising determining a device lid state indicating a device lid is closed.

4. The method of claim 1, wherein analyzing the ultrasound echo includes inputting the ultrasound echo to a neural network, and wherein determining that the device is in the enclosure includes determining by the neural network that the device is in the enclosure.

5. The method of claim 1, wherein analyzing the ultrasound echo includes comparing, at a correlator, the ultrasound echo to the ultrasound signal and identifying early reflections.

6. The method of claim 1, further comprising preventing the device from entering a high power state.

7. The method of claim 1, wherein the selected event is a first selected event, and further comprising detecting a second selected event in the ambient acoustic input, wherein the second selected event indicates the device is out of the enclosure.

8. One or more non-transitory computer-readable media storing instructions executable to perform operations, the operations comprising:
receiving an ambient acoustic input;
detecting a selected event in the ambient acoustic input, wherein the selected event indicates the device is in an enclosure;
generating an ultrasound signal;
analyzing an ultrasound echo of the ultrasound signal; and
determining, based on the ultrasound echo, that the device is in the enclosure.

9. The one or more non-transitory computer-readable media of claim 8, the operations further comprising limiting the device to a lower power state while the device is in the enclosure.

10. The one or more non-transitory computer-readable media of claim 8, the operations further comprising determining a device lid state indicating a device lid is closed.

11. The one or more non-transitory computer-readable media of claim 8, wherein analyzing the ultrasound echo includes inputting the ultrasound echo to a neural network, and wherein determining that the device is in the enclosure includes determining by the neural network that the device is in the enclosure.

12. The one or more non-transitory computer-readable media of claim 8, wherein analyzing the ultrasound echo includes comparing, at a correlator, the ultrasound echo to the ultrasound signal and identifying early reflections.

13. The one or more non-transitory computer-readable media of claim 8, the operations further comprising preventing the device from entering a high power state.

14. The one or more non-transitory computer-readable media of claim 8, wherein the selected event is a first selected event, and further comprising detecting a second selected event in the ambient audio input, wherein the second selected event indicates the device is out of the enclosure.

15. An apparatus, comprising:
a computer processor for executing computer program instructions; and
a non-transitory computer-readable memory storing computer program instructions executable by the computer processor to perform operations comprising:
receiving an ambient acoustic input;
detecting a selected event in the ambient acoustic input, wherein the selected event indicates the device is in an enclosure;
generating an ultrasound signal;
analyzing an ultrasound echo of the ultrasound signal; and
determining, based on the ultrasound echo, that the device is in the enclosure.

16. The apparatus of claim 15, the operations further comprising limiting the device to a lower power state while the device is in the enclosure.

17. The apparatus of claim 15, the operations further comprising determining a device lid state indicating a device lid is closed.

18. The apparatus of claim 15, wherein analyzing the ultrasound echo includes inputting the ultrasound echo to a neural network, and wherein determining that the device is in the enclosure includes determining by the neural network that the device is in the enclosure.

19. The apparatus of claim 15, wherein analyzing the ultrasound echo includes comparing, at a correlator, the ultrasound echo to the ultrasound signal and identifying early reflections.

20. The apparatus of claim 15, the operations further comprising preventing the device from entering a high power state.
